(19) United States
(12) Patent Application Publication
(10) Pub. No.: US 2023/0264176 A1
(43) Pub. Date: Aug. 24, 2023

(54) METHOD FOR PRODUCING CATALYST FOR ELECTROCHEMICAL REACTION THAT CAN BE SIZED INTO FINE PARTICLES

(71) Applicants: HYUNDAI MOTOR COMPANY, Seoul (KR); KIA CORPORATION, Seoul (KR)

(72) Inventor: Hee Su Yang, Seoul (KR)

(21) Appl. No.: 18/082,279

(22) Filed: Dec. 15, 2022

(30) Foreign Application Priority Data
Feb. 21, 2022 (KR) 10-2022-0021856

(51) Int. Cl. B01J 23/46; B01J 37/02; B01J 37/08; B01J 35/10

(52) U.S. Cl. CPC B01J 23/468; B01J 37/0236; B01J 37/084; B01J 35/1014

(57) ABSTRACT

A method for producing a catalyst for an electrochemical reaction that can be sized into fine particles while having a high specific surface area by using a carbon-based spacer in the catalyst synthesis process includes preparing a mixture by mixing a carbon-based spacer and a catalyst precursor and heat-treating the mixture.

### CROSS REFERENCE TO RELATED APPLICATIONS

The present application claims priority to Korean Patent Application No. 10-2022-0021856, filed Feb. 21, 2022, the entire contents of which is incorporated herein for all purposes by this reference.

### BACKGROUND

### 1. Field

The present disclosure relates to a method for producing a catalyst for an electrochemical reaction that can be sized into fine particles while having a high specific surface area by using a carbon-based spacer in the catalyst synthesis process.

### 2. Description of the Related Art

Among the catalytic synthesis methods, the Adams' Fusion synthesis is the first reported synthesis by Roger Adams. The Adams' Fusion synthesis method is a synthesis method capable of synthesizing platinum oxide called Adams' Catalyst used for hydrogenation.

The synthesis method is applied as a method of synthesizing a metal oxide such as iridium oxide in addition to platinum oxide.

The synthesis method is a general framework to heat-treat a mixture of chloroplatinic acid, ammonium chloroplatinate, and sodium nitrate at 400° C. or higher. In general, the dry synthesis method is impossible to control the size of the catalyst particles like the wet synthesis method.

Therefore, in the above dry synthesis method, since a catalyst having a large size of 500 μm or more is synthesized, it is difficult to exhibit good catalytic activity in terms of surface area compared to a catalyst whose particle size is adjusted to be small in surface reactions such as electrochemical reactions.

Conventionally, using the Adams' Fusion synthesis method, silica nanopores or ammonia were added together with a metal precursor or sodium nitrate to form micro or meso-sized pores in the catalyst, and thus, the surface area of the catalyst was increased to improve the activity of the catalyst.

In order to increase the surface area of the synthesized catalyst, the method using silica nanospheres can create small pores in the catalyst mass or the method using ammonia as a chelate agent can create pores of various sizes between each metal crystal.

The above two synthesis methods showed improved catalytic activity with increased surface area.

On the other hand, the synthesis method of creating pores inside the catalyst using silica nanospheres has a disadvantage in that the process steps become complicated because the silica nanopores used for forming holes after heat treatment should be melted through chemical etching, and the process step becomes complicated. At this time, there is a risk that the silica that is not removed properly blocks the active area and reduces the efficiency of the reaction.

In addition, the synthesis method of using ammonia to increase the surface area by creating a pore between the crystals can be easily removed by dissolving ammonia in distilled water in the filtering process, which is one of the existing synthesis processes. However, if ammonia is not properly removed, there is a risk that the pH of the reaction may be changed to degrade the catalytic activity and prevent the reaction itself from occurring.

In addition, since the particle size itself is not reduced in the two conventional methods, there is a problem in that the gas is trapped in the pores generated in the catalyst particles in a fuel cell or water decomposition reaction that uses gas or generates gas, thereby reducing the active area under driving conditions.

Therefore, under the above background, the development of a catalyst producing method capable of controlling the size of fine particles while having a high specific surface area in the dry synthesis method of the catalyst is required.

### SUMMARY

An objective of the present disclosure is to provide a method for producing a catalyst capable of controlling the size of fine particles while having a high specific surface area in a dry synthesis method of a catalyst.

The objective of the present disclosure is not limited to the objective mentioned above. The objectives of the present disclosure will become more apparent from the following description and will be realized by means and combinations thereof described in the claims.

The method for producing a catalyst, according to the present disclosure, includes preparing a mixture by mixing a carbon-based spacer and a catalyst precursor and heat-treating the mixture.

The method for producing the catalyst may further include preparing a starting material by adding the carbon-based spacer and the catalyst precursor to a solvent, which is performed before the step of preparing the mixture.

It may be to prepare a mixture by drying the starting material.

The carbon-based spacer may form a gap between the catalyst precursors.

The carbon-based spacer may include at least one selected from the group consisting of Vulcan carbon, Ketjen black, carbon nanotube, carbon black, reduced graphene oxide, and graphene oxide.

The catalyst precursor may include at least one selected from the group consisting of a metal precursor and a sodium nitrate precursor.

The metal precursor may include at least one selected from the group consisting of a metalloid, an alkali metal, an alkaline earth metal, and a transition metal.

The metalloid includes at least one selected from the group consisting of boron (B), silicon (Si), germanium (Ge), arsenic (As), antimony (Sb), tellurium (Te), and polonium (Po). The alkali metal includes at least one selected from the group consisting of lithium (Li), sodium (Na), potassium (K), rubidium (Rb), cesium (Cs), and francium (Fr). The alkaline earth metal includes at least one selected from the group consisting of beryllium (Be), magnesium (Mg), calcium (Ca), strontium (Sr), barium (Ba), and radium (Ra). The transition metal may include at least one selected from the group consisting of scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf)), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), meitnerium (Mt), darmstadtium (Ds), roentgenium (Rg), and copernicium (Cn).

In preparing the mixture, the mixture may be mixed in 100 parts by weight of the catalyst precursor and 10 to 10,000 parts by weight of the carbon-based spacer.

The step of heat-treating the mixture may include carbonizing the carbon-based spacer to remove carbon included in the mixture to form pores in the mixture.

The heat treatment may be performed in a temperature range of 150° C. to 950° C.

The method for producing the catalyst may further include pulverizing the heat-treated product.

In the method for producing the catalyst, the specific surface area of the catalyst may have a range of 10 to 100 m²/g.

In the present disclosure, by using a carbon-based spacer in the catalyst synthesis process, a catalyst having a high specific surface area and a fine particle size can be produced.

In addition, according to the present disclosure, since most of the carbon is carbonized and removed through heat treatment, an additional process is not required in a generally used Adams' Fusion synthesis method, and thus a catalyst producing process is very simple, thereby easily producing a large amount of a catalyst.

The effects of the present disclosure are not limited to the effects mentioned above. It should be understood that the effects of the present disclosure include all effects that can be inferred from the following description.

### BRIEF DESCRIPTION OF THE FIGURES

FIG. 1 is a flowchart showing a method of producing a catalyst according to the present disclosure;

FIG. 2 is a schematic diagram of a method for producing a catalyst according to the present disclosure;

FIGS. 3A and 3B are TEM images of a catalyst produced by a catalyst producing method according to the related art;

FIG. 4A is a TEM image of a catalyst produced by a catalyst producing method according to the Comparative Example;

FIG. 4B is a BET result of a catalyst produced by a catalyst producing method according to the Comparative Example;

FIG. 5A is a TEM image of a catalyst produced by a catalyst producing method according to the Example;

FIG. 5B is a BET result of a catalyst produced by a catalyst producing method according to the Example; and

FIG. 5C is a TGA result of a catalyst produced by a catalyst producing method according to the Example.

### DETAILED DESCRIPTION

The above objectives, other objectives, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In this specification, the terms “include” or “have” should be understood to designate that one or more of the described features, numbers, steps, operations, components, or a combination thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where there is another part in between. Conversely, when a part of a layer, film, region, plate, etc., is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, it should be understood as being modified by the term “about” in all cases. In addition, when a numerical range is disclosed in this disclosure, this range is continuous and includes all values from the minimum to the maximum value containing the maximum value of this range unless otherwise indicated. Furthermore, when such a range refers to an integer, all integers, including the minimum value to the maximum value containing the maximum value, are included unless otherwise indicated.

First, before explaining the present disclosure, the present disclosure is to provide a metal oxide synthesis method to which a carbon-based spacer is applied in the Adams' Fusion synthesis method.

The present disclosure relates to a method for producing a catalyst for an electrochemical reaction capable of controlling the size of fine particles. Hereinafter, the present disclosure will be described in more detail with reference to the accompanying drawings.

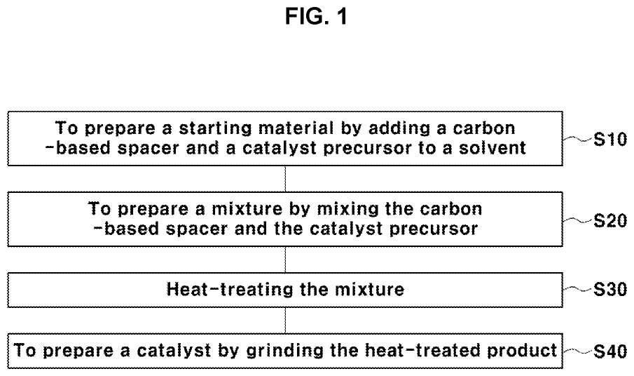

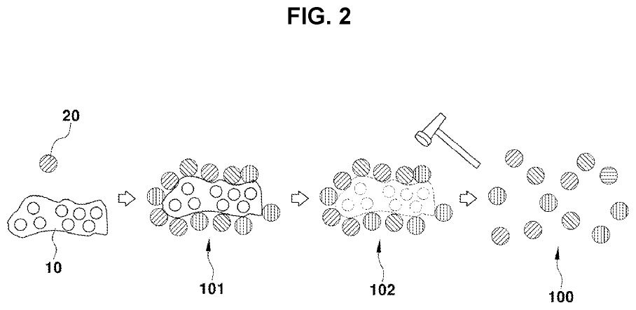

FIG. 1 is a flowchart showing a method of producing a catalyst according to the present disclosure. FIG. 2 is a schematic diagram of a method for producing a catalyst according to the present disclosure.

Referring to FIG. 2, the catalyst producing method includes preparing a starting material by adding a carbon-based spacer and a catalyst precursor to a solvent S10, preparing a mixture by mixing the carbon-based spacer and a catalyst precursor S20, heat-treating the mixture S30, and pulverizing the heat-treated product S40.

First, in step S10, the carbon-based spacer 10 and the catalyst precursor 20 are added to a solvent to prepare a starting material.

The solvent may use an organic solvent such as isopropyl alcohol(IPA), ethanol, and the like.

In the present disclosure, in producing a metal oxide catalyst, the carbon-based spacer 10 is mixed with the catalyst precursor 20 in order to prevent aggregation of the catalyst particles.

The carbon-based spacer 10 may include at least one selected from the group consisting of Vulcan carbon, Ketjen black, carbon nanotube, carbon black, reduced graphene oxide, and graphene oxide.

The catalyst precursor 20 may include at least one selected from the group consisting of a metal precursor and a sodium nitrate precursor.

The metal precursor may include at least one selected from the group consisting of a metalloid, an alkali metal, an alkaline earth metal, and a transition metal.

The metalloid includes at least one selected from the group consisting of boron (B), silicon (Si), germanium (Ge), arsenic (As), antimony (Sb), tellurium (Te), and polonium (Po). The alkali metal includes at least one selected from the group consisting of lithium (Li), sodium (Na), potassium (K), rubidium (Rb), cesium (Cs), and francium (Fr). The alkaline earth metal includes at least one selected from the group consisting of beryllium (Be), magnesium (Mg), calcium (Ca), strontium (Sr), barium (Ba), and radium (Ra). The transition metal may include at least one selected from the group consisting of scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), meitnerium (Mt), darmstadtium (Ds), roentgenium (Rg), and copernicium (Cn).

Subsequently, in step S20, the mixture 101 is produced by mixing the carbon-based spacer 10 and the catalyst precursor 20.

In this case, the mixing method is not particularly limited, and mixing may be performed using a mixer such as a Thinky Mixer, a minimill, a planetary mixer, a ball mill equipment, Magnetic Stirrer, or a Homo mixer.

The mixture 101 may be a mixture of 100 parts by weight of the catalyst precursor 20 and 10 to 10,000 parts by weight of the carbon-based spacer 10.

In this case, the mixture 101 may be produced by drying the starting material by evaporating the solvent through stirring and heat treatment. Here, stirring may be performed for 10 to 30 minutes.

Subsequently, in step S30, heat-treating is performed on the remaining powdery mixture 101 after all of the solvents is evaporated to produce a heat-treated product 102.

The heat-treating may be performed in a temperature range of 150° C. to 950° C.

At this time, by carbonizing the carbon-based spacer 101, carbon included in the mixture 101 may be removed to form pores in the mixture.

Accordingly, through the heat-treating process, most of the carbon-based spacer 10 is removed, and the catalyst 100 having an increased specific surface area can be obtained. The catalyst 100 from which the carbon-based spacer 10 is removed may be physically easily pulverized.

Accordingly, the carbon-based spacer 10 serves to form a gap between the catalyst precursors 20, and is removed during the heat-treating process after the role is finished.

Therefore, the carbon-based spacer 10 does not use carbon as a support, and specifically, a pure metal oxide other than a catalyst composite such as Pt/C may be produced.

Thereafter, the heat-treated product 102 may additionally undergo a process of dissolving and removing materials other than the catalyst using distilled water.

Finally, in step S40, the heat-treated product 102 is pulverized to finally produce the catalyst 100.

The pulverizing may be performed by using pulverizing equipment such as a ball mill, thereby producing the catalyst 100 having a fine particle size while having a high specific surface area. Here, the specific surface area of the catalyst 100 as a final product may be 10 to 100 m²/g.

On the other hand, the catalyst 100 produced by the catalyst producing method, according to the present disclosure, is a metal oxide, and the type of metal synthesized cannot be limited.

In addition, a material that can be used as the carbon-based spacer 10 is not limited as long as it forms a gap between the catalyst precursors 20.

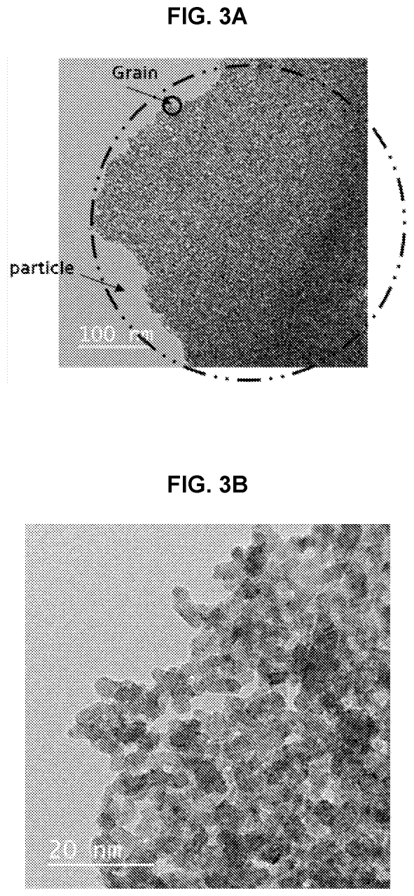

On the other hand, FIGS. 3A and 3B are TEM images of a catalyst produced by a catalyst producing method according to the related art. Referring to FIGS. 3A and 3B, when the catalyst is synthesized by the conventional metal oxide synthesis method (Adams' Fusion synthesis method), since no solvent is used, and thus grains formed at each part of a reaction vessel form a grain boundary that is not easily broken by a general physical grinding method.

Accordingly, the grain boundary means that it is difficult for the grains to be separated one by one, and unlike a catalyst in which the grains are separated one by one and behave separately, the grain boundary tends to behave together with peripheral elements.

Hereinafter, the present disclosure will be described in more detail through specific experimental examples. The following experimental examples are only examples to help the understanding of the present disclosure, and the scope of the present disclosure is not limited thereto.

### EXAMPLE

First, an Iridium oxide (IrO₂) catalyst was produced by the catalyst producing method according to the present disclosure.

Specifically, hexachloroiridic acid (H₂IrC₁₆) purchased from Sigma Aldrich Co., Ltd. was placed in a solvent mixed with IPA and EtOH and stirred for 20 minutes to dissolve.

Subsequently, sodium nitrate and carbon-based spacers purchased from Samjeon Co., Ltd. were added to the solution at a mass ratio of 15:1 (using 15 g and 1 g, respectively), stirring was performed, and then the solvent was completely evaporated through heat-treating. Here, Vulcan carbon was used as a carbon-based spacer.

Then, the mixture in the form of a powder in which the solvent was evaporated was subjected to heat treatment at 400° C. in a furnace.

Finally, using distilled water, materials other than the catalyst were dissolved and removed to finally produce an IrO₂ catalyst.

### Comparative Example

Then, an IrO₂ catalyst was produced by the catalyst producing method according to Comparative Example using the conventional metal oxide synthesis method. The IrO₂ catalyst, according to the Comparative Example, was produced in the same manner as in Example, except that a carbon-based spacer was not used.

Specifically, H₂IrC₁₆ purchased from Sigma Aldrich Co., Ltd. was placed in a solvent mixed with IPA and EtOH and stirred for 20 minutes to dissolve.

Then, 15 g of sodium nitrate purchased from Samjeon Co., Ltd. was added to the solution, stirred, and then all of the solvents was evaporated through heat-treating.

Then, the mixture in the form of a powder in which the solvent was evaporated was subjected to heat treatment at 400° C. in a furnace.

Finally, using distilled water, materials other than the catalyst were dissolved and removed to finally produce an IrO₂ catalyst.

First, in order to confirm the characteristics of the catalyst produced in the Comparative Example, the structure and specific surface area were analyzed through a transmission electron microscope (TEM) and Brunauer-Emmett-Teller analysis (BET).

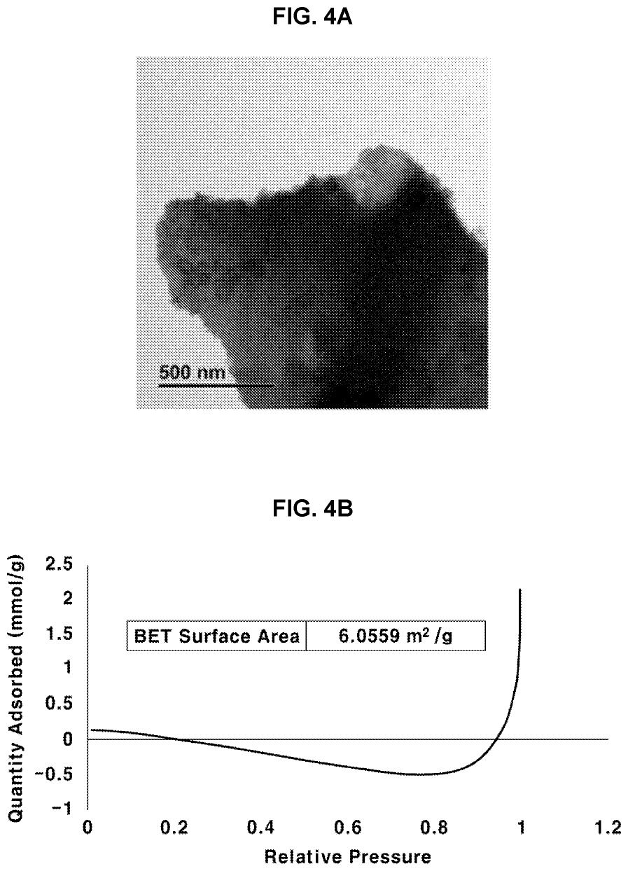

FIG. 4A is a TEM image of a catalyst produced by a catalyst producing method according to the Comparative Example. As shown in FIG. 4A, it is shown that all the small particles in the catalyst are aggregated to form particles having a size of 1 μm or more.

In addition, before taking the TEM image, the catalyst produced in the Comparative Example was physically broken using a sonicator and a mortar, but as shown in the image, it can be seen that the catalyst particles are still large and small particles are densely attached.

Therefore, it was confirmed that the particle size of the catalyst produced by the synthesis of the catalyst according to the Comparative Example was difficult to be adjusted to a fine size.

FIG. 4B is a BET result of a catalyst produced by a catalyst producing method according to the Comparative Example. As shown in FIG. 4B, it was confirmed that the catalyst produced by the synthesis of the conventional method had a BET surface area value of 6.0559 m²/g.

Subsequently, in order to confirm the characteristics of the catalyst prepared in Examples, the structure, and specific surface area were analyzed using a Transmission Electron Microscope (TEM) and Brunauer-Emmett-Teller analysis (BET).

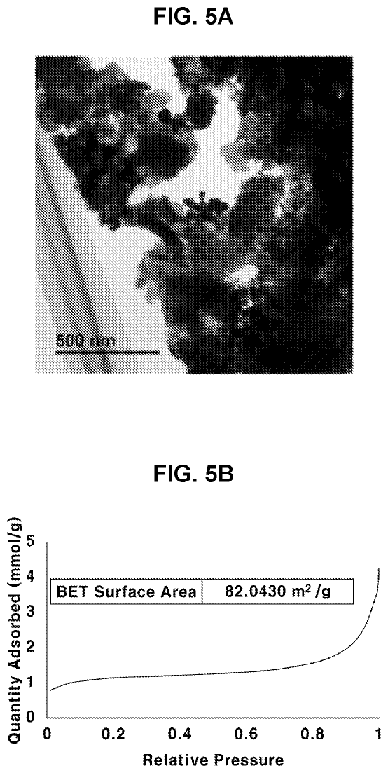

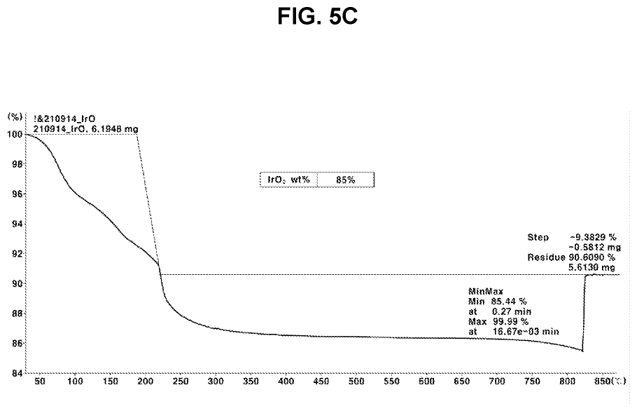

FIG. 5A is a TEM image of a catalyst produced by a catalyst producing method according to the Example. As shown in FIG. 5A, it can be seen that a large hole (pore) is formed in the catalyst, and it can also be seen in the image that the catalyst is broken and separated due to the hole.

Therefore, the catalyst produced according to the present disclosure may be formed in a structure in which a plurality of pores is formed therein to be easily physically pulverized. Since the catalyst may be produced with a fine particle size by a grinding manner, gas is not trapped in the pores under the driving conditions when the catalyst is used, thereby maintaining the catalyst activity throughout the operation without reducing the active area.

FIG. 5B is a BET result of a catalyst produced by a catalyst producing method according to the Example. As shown in FIG. 5B, it was confirmed that the BET surface area value of the catalyst produced by the catalyst producing method, according to the present disclosure, was 82.0430 m²/g.

Therefore, it can be seen that the IrO₂ catalyst produced according to the Example has a specific surface area value that is 13.5 times or greater than that of the IrO₂ catalyst produced according to the Comparative Example.

Therefore, in the present disclosure, the size of the catalyst particles may be adjusted to be small through the process of adding a carbon-based spacer during the synthesis process, and thereby, the surface area that is directly helpful to the improvement of the catalyst activity can be increased by 13 times or more.

Thus, the present disclosure means that although the same amount of catalyst precursors is used, catalyst precursors, according to the present disclosure, have a much larger surface area.

Therefore, the catalyst produced, according to the present disclosure, has a fine particle size to maximize the surface area and ultimately has the effect of improving the activity of the catalyst for electrochemical reaction.

Additionally, in order to confirm that the carbon-based spacer was removed through the heat treatment, the components of the catalyst after heat-treating were analyzed through thermogravimetric analysis (TGA).

FIG. 5C is a TGA result of a catalyst produced by a catalyst producing method according to the Example. As shown in FIG. 5C, the mass of the metal in the metal precursor and the Vulcan carbon was 14.3% by weight, but the mass of the metal after heat-treating was confirmed to be 85% by weight. This means that most of the carbon is removed during the heat-treating process.

Therefore, the present disclosure does not require additional synthetic materials by using previously proven carbon, rather than adding impurities that inhibit catalyst activity under driving conditions during the electrochemical reaction, and there is an advantage that most carbons are removed during the heat treatment process.

On the other hand, even if some carbon remains, this disclosure does not cause a degradation in the activity in the reaction because it is a material that is already used as a support for an electrochemical catalyst.

In addition, the present disclosure does not need to add a process of removing the carbon-based spacer by utilizing the carbon that is vaporized and blown away from the carbon-based spacer in the heat-treating process, which is one of the synthesis processes.

Although the embodiment of the present disclosure has been described with reference to the accompanying drawings, it will be understood by those skilled in the art that the present disclosure may be implemented in other specific forms without changing the technical spirit or essential features thereof. Therefore, it should be understood that the embodiments described above are illustrative in all respects and not restrictive.

1. A method for producing a catalyst comprising:
preparing a mixture by mixing a carbon-based spacer and a catalyst precursor; and
heat-treating the mixture.

2. The method of claim 1, wherein the method further comprises preparing a starting material by introducing the carbon-based spacer and the catalyst precursor into a solvent, which is performed before the step of preparing the mixture.

3. The method of claim 2, wherein the method further comprises preparing a mixture by drying the starting material.

4. The method of claim 1, wherein the carbon-based spacer forms a gap between the catalyst precursors.

5. The method of claim 1, wherein the carbon-based spacer comprises at least one of Vulcan carbon, Ketjen black, carbon nanotube, carbon black, reduced graphene oxide, graphene oxide, or any combination thereof.

6. The method of claim 1, wherein the catalyst precursor comprises at least one of a metal precursor, a sodium nitrate precursor, or any combination thereof.

7. The method of claim 6, wherein the metal precursor comprises at least one selected from the group consisting of: a metalloid, an alkali metal, an alkaline earth metal, and a transition metal.

8. The method of claim 7, wherein the metalloid comprises at least one of boron, silicon, germanium, arsenic, antimony, tellurium, polonium, or any combination thereof;
the alkali metal comprises at least one of lithium, sodium, potassium, rubidium, cesium, francium, or any combination thereof;
the alkaline earth metal comprises at least one of beryllium, magnesium, calcium, strontium, barium, radium, or any combination thereof; and
the transition metal comprises at least one of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, darmstadtium, roentgenium, copernicium, or any combination thereof.

9. The method of claim 1, wherein, in preparing the mixture, the mixture is mixed in 100 parts by weight of the catalyst precursor and an amount of about 10 to 10,000 parts by weight of the carbon-based spacer.

10. The method of claim 1, wherein, in heat-treating the mixture, the carbon-based spacer is carbonized to remove the carbon contained in the mixture to form pores in the mixture.

11. The method of claim 1, wherein the heat-treating is performed in a temperature range of 150° C. to 950° C.

12. The method of claim 1, wherein the method further comprises pulverizing the heat-treated product.

13. The method of claim 1, wherein the specific surface area of a catalyst is in the range of 10 to 100 m²/g.
